(19) United States
(12) Patent Application Publication
(10) Pub. No.: US 2020/0156723 A1
(43) Pub. Date: May 21, 2020

(54) TRAINING WHEELS FOR BICYCLE

(71) Applicants: Shane Patrick Booker, JR., Lockport, NY (US); Alex Scott Pittner, Charleston, SC (US)

(72) Inventors: Shane Patrick Booker, JR., Lockport, NY (US); Alex Scott Pittner, Charleston, SC (US)

(21) Appl. No.: 16/683,862

(22) Filed: Nov. 14, 2019

Related U.S. Application Data
(60) Provisional application No. 62/770,526, filed on Nov. 21, 2018.

(51) Int. Cl. B62H 1/12; B62H 7/00

(52) U.S. Cl. CPC B62H 1/12; B62H 7/00

(57) ABSTRACT

A bicycle training wheel assembly that allows riders to lean from side to side, thereby enabling the rider to practice balancing skills. The bicycle training wheel assembly has adjustable maximum tilt settings that train the rider in increments as they learn to balance on a bicycle. An omnidirectional wheel accommodates lateral rotational components to prevent skidding of the wheel when the bicycle is tilted towards or away from a training wheel assembly.

### CROSS-REFERENCE TO RELATED APPLICATION

This application claims the benefit of priority of U.S. provisional application No. 62/770,526, filed Nov. 21, 2018, the contents of which are herein incorporated by reference.

### BACKGROUND OF THE INVENTION

The present invention relates bicycle training devices, and more particularly to training wheels.

Present training wheels do not adequately train new riders the balancing aspects of riding a bicycle. This is because current training wheel systems provide the wheels in a fixed position that maintains the bicycle in completely upright orientation.

These current bicycle training systems handicap the rider and give a false sense of ability. Riders that learn on current training wheel embodiments are not trained in balance when they stop use of this training systems.

As can be seen, there is a need for an improved training wheel system that trains the rider in the balancing aspect of riding a bicycle.

### SUMMARY OF THE INVENTION

In one aspect of the present invention, a training wheel assembly for a bicycle is disclosed. The training wheel assembly includes a U-shaped bracket having a base adapted for attachment to a frame of the bicycle. Legs of the U-shaped bracket extend from the base. The have a pivot aperture and a plurality of adjustment apertures disposed in a spaced apart relationship. A support arm is pivotally coupled to the U-shaped bracket via a pivot pin extending through a proximal end of the support arm. A distal end of the support arm is adapted to rotationally carry a training wheel. An adjustment pin is movably received in a selected adjustment aperture. The adjustment pin is disposed to limit an upward pivoting of the support arm when an attached training wheel contacts a riding surface during a tilting of the bicycle.

In some embodiments, a biasing means urges the support arm in a downward orientation. The biasing means may include a spring. The spring may be carried on the pivot pin.

In other embodiments, a training wheel is mounted for axial rotation to the distal end of the support arm. The training wheel may be an omnidirectional wheel.

The omnidirectional wheel may include a plurality of rollers circumferentially disposed about an outer edge of the training wheel. The plurality of rollers are oriented for rotation orthogonal to a rotation axis of the training wheel. The purpose of the omnidirectional wheel is to prevent skidding along the riding surface as the distance of the wheel to the bicycle changes while the bicycle tilts during training.

In yet other embodiments the distal end of the support arm is adjustably attached to the proximal end of the support arm.

In other aspects of the invention a training wheel assembly for a bicycle includes a bracket having a base adapted for attachment to a frame of the bicycle. A support arm is pivotally coupled to the bracket via a pivot pin extending through a proximal end of the support arm. A training wheel is attachable to a distal end of the support arm. An adjustment pin is adjustably attached to the bracket. The adjustment pin limits an upward movement of the support arm when an attached training wheel contacts a ground surface. These adjustments to the limit of upward motion of the support arm constitute levels of skill attained by a rider using this invention.

These and other features, aspects and advantages of the present invention will become better understood with reference to the following drawings, description and claims.

### BRIEF DESCRIPTION OF THE DRAWINGS

FIG. 1 is a perspective view of the invention in use.

FIG. 2 is an exploded perspective view.

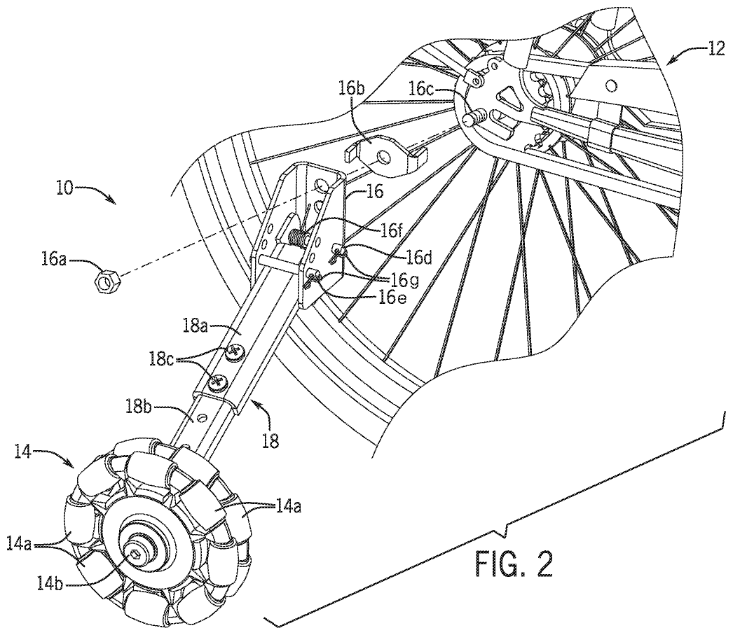

FIG. 3 is a detail exploded perspective view.

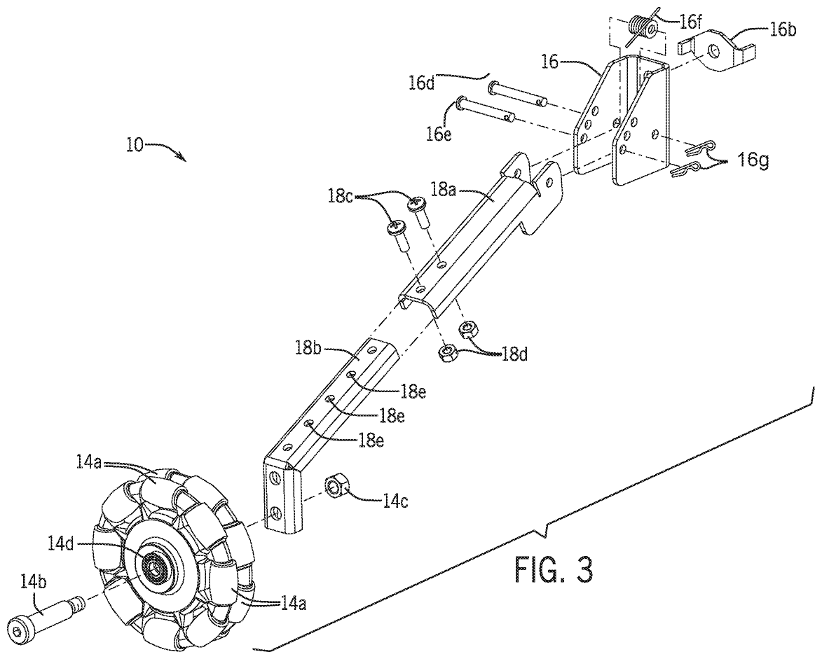

FIG. 4 is a rear elevation view.

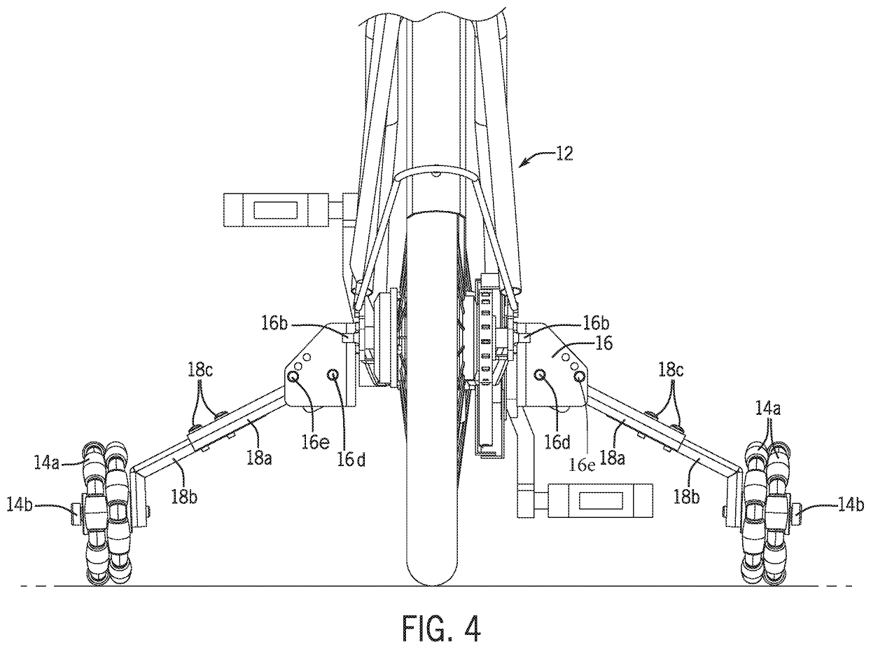

FIG. 5 is a detail cross-sectional view.

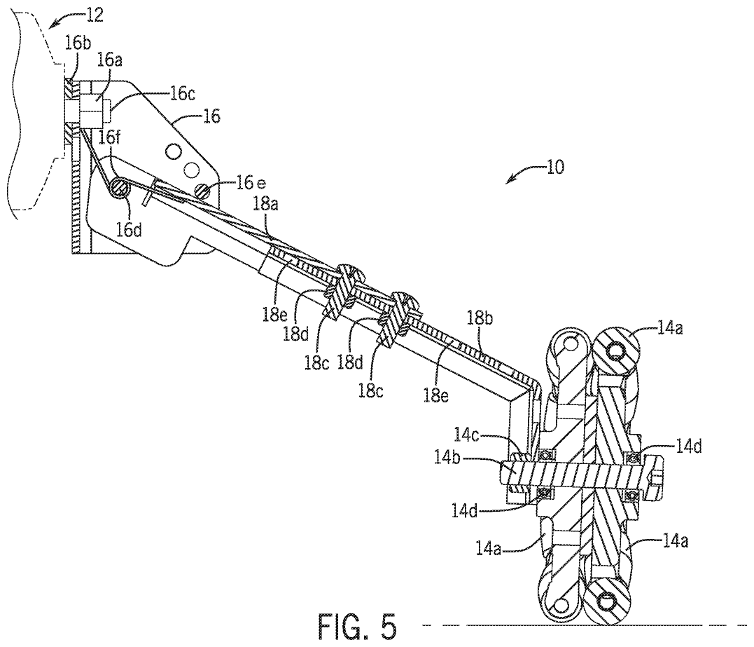

FIG. 6 is a detail cross-sectional view, similar to FIG. 5, with the bicycle shown in an alternate position.

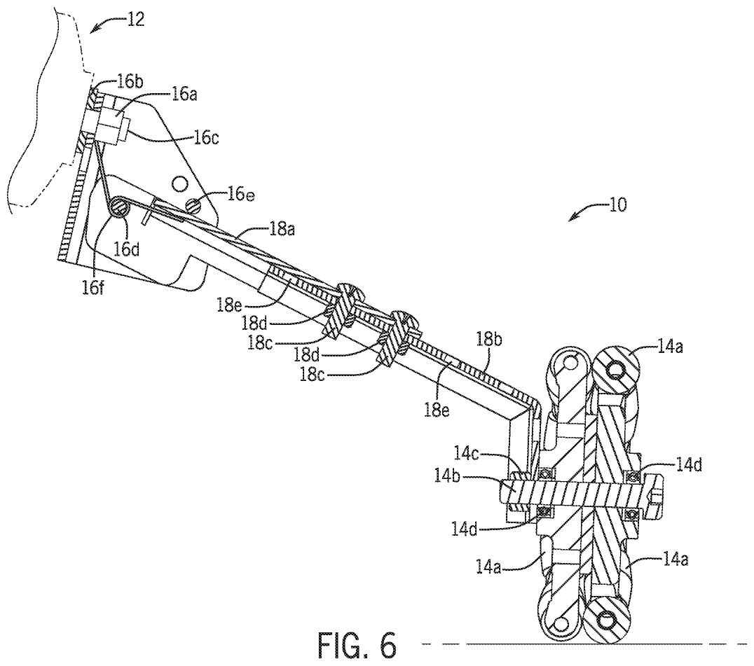

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved training wheel assembly that allows the rider to tilt the bicycle to each side. The training wheel assembly has adjustable levels of allowable tilt that trains the rider in increments as they learn to balance on a bicycle, allowing tilting of the bicycle without the bicycle tipping over.

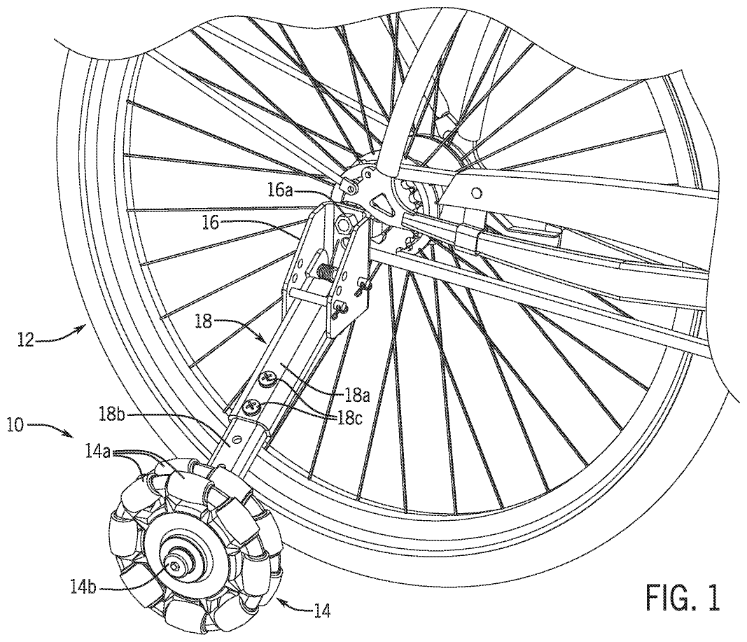

As seen in reference to the drawings of FIG. 1 a bicycle training wheel assembly 10 is illustrated attached to a mounting point on a bicycle 12. The bicycle training wheel assembly 10 is fitted with a wheel 14 that is rotationally attached to a support arm 18 via a fastener 14b, such as a bolt, a retaining cap, an axle nut. In a preferred embodiment, the wheel 14 is an omnidirectional wheel.

The training wheel assembly 10 includes a bracket 16 that is secured to an aft end of the bicycle 12. The bracket 16 may be secured to the bicycle 12 with a washer 16b that is carried on an axle 16c of a rear wheel of the bicycle 12. The washer includes a first tang extending therefrom to be received within an axle slot of the bicycle frame 12. A second tang may extend in an opposite direction from the first tang and is oriented to align the bracket 16 in a desired vertical orientation.

The bracket 16 may be formed in a U-shape with a base of the bracket having at least one mounting hole oriented to receive the axle 16c. A plurality of mounting holes may be vertically disposed on the base to accommodate the training wheel assembly to bicycles having wheels of various radii.

Legs of the bracket are provided with a pivot aperture that receives a pivot pin 16d for attachment of a proximal end of a support arm 18. A plurality of adjustment apertures are provided along a distal end of the bracket legs. The adjustment apertures receive an adjustment pin 16e which limit vertical displacement of the support arms 18. A torsion spring 16f biases the support arm 18 in a downward direction. The torsion spring 16f may be carried on the pivot pin 16d. A first spring arm may be positioned in abutment with the base and a second spring arm may be positioned in abutment with the support arm 18. A cotter pin 16g may secure the pivot pin 16d and the adjustment pin 16e within the apertures.

The biased support arms 18 and pivoting mount to the bracket 16 allows the wheel 14 position and angle to adjust to the riders tilt on the bicycle 12. The varying the position of the adjustment pin 16e in the adjustment apertures allow the training wheel assembly 10 to be adjusted at increments as the rider learns balance on the bicycle 12. The biased support arms 18 also assists the rider in returning the bicycle 12 to the upright and stable position.

The support arm 18 has a proximal end 18a and a distal end 18b. The proximal 18a and distal ends 18b may be joined by a fastener 18c and a cooperating nut 18d. The proximal end 18a and the distal end 18b are preferably adjustable in length via a length adjustment aperture 18e configured to receive the fastener 18c. A bottom portion of the distal end 18b is configured to receive attachment of the wheel 14. The length adjustment of the support arm 18 permits the training wheel assembly 10 to be adjusted to different wheel radii and bicycle frame sizes, as well as providing further adjustment as the rider develops their balancing skills.

The omnidirectional wheel 14 includes a plurality of rollers 14a circumferentially disposed about a carrier wheel. The rollers 14a are oriented for axial rotation orthogonal to a rotational plane of the wheel 14 about a hub 14d. The omnidirectional wheel 14 may include an inner and an outer wheel segment. The omnidirectional wheel 14 allows the bicycle 12 to tilt without the wheel 14 skidding across the riding surface as the distance of the wheel to the bicycle changes while the bicycle tilts during training.

The purpose of the training wheel assembly 10 is to assist a rider when they are learning to ride a bicycle 12. The adjustable upper limit to the support arms 18 adjusts the range of motion and determines the amount of leaning the bicycle 12 can do. This increased leaning capability teaches the rider to balance while riding a bicycle 12 in graduated steps. Each step is a graduation to a higher level of balance skill. The biasing of the support arms 18 returns the device 10 to the lower position for safety and rider confidence that the device 10 will prevent them from falling over. It also provides assistance to the rider for returning the bicycle to the upright and stable position.

The hub mounting bracket 16 may be fabricated from square steel tubing. A section of appropriate length is cut, the top is beveled, and the front wall is cut away. A hole is drilled in the base side of the bracket 16 so it can slide over the threaded axle 16c of the bicycle 12. The proximal end 18a of the support arm 18 has a plate with a hole in it for receiving the pivot pin 16d for attachment to the bracket 16. A bottom end of the proximal end 18a has an angled portion that serves as a lower stop to limit the motion of the support arm 18.

The training wheel assembly may be utilized according to the following method to train a rider that is learning to ride a bicycle 12:

Training wheel assembly 10 is attached to the bicycle 10 via the hub mounting bracket 16. The length of the adjustable arms 18 are set so that the wheel 14 is positioned approximately ¼ inch above the riding surface. A tilt limit is set by positioning of the adjustment pin 16e in the bracket 16. The tilt limit is set to the rider's skill level. For beginning riders, the tilt limit to the support arm 18 is set a first level of tilt. For intermediate skill riders, the tilt limiter can be set to an intermediate setting.

Once set, the rider mounts the bicycle 12 and attempts specified maneuvers. A supervisor and the rider may agree when rider is ready for next level of tilt, at which point, a next level of tilt is set by adjustment of the adjustment pin 16e. The supervisor and rider progress through settings of the adjustment pin 16e until they agree the rider is ready to attempt riding the bicycle without assistance from the training wheel assembly.

When the rider is ready, the support arms 18 may then be moved to a storage setting, with the adjustment pin 16e received through the upper adjustment aperture and the support arm 18 supported in an upright position by the adjustment pin 16e.

The rider may then attempt set maneuvers without aid of the training wheel assembly 10. The rider will repeat highest level of the adjustment pin 16e if they fail to remain upright while riding bicycle 12.

It should be understood, of course, that the foregoing relates to exemplary embodiments of the invention and that modifications may be made without departing from the spirit and scope of the invention as set forth in the following claims.

What is claimed is:

1. A training wheel assembly for a bicycle, comprising:
a U-shaped bracket having a base adapted for attachment to a frame of the bicycle, legs of the U-shaped bracket extending from the base, the legs having a pivot aperture and a plurality of adjustment apertures disposed in a spaced apart relationship;
a support arm pivotally coupled to the U-shaped bracket via a pivot pin extending through a proximal end of the support arm;
a distal end of the support arm adapted rotationally carry a training wheel; and
an adjustment pin movably received in a selected adjustment aperture, the adjustment pin disposed to limit an upward pivoting of the support arm when the training wheel contacts a riding surface during a tilting of the bicycle.

2. The training wheel assembly if claim 1, further comprising:
a biasing means to urge the support arm in a downward orientation.

3. The training wheel assembly of claim 2, wherein the biasing means comprises a spring.

4. The training wheel assembly of claim 3, wherein the spring is carried on the pivot pin.

5. The training wheel assembly of claim 1, further comprising:
the training wheel mounted for axial rotation to the distal end of the support arm.

6. The training wheel assembly of claim 5, wherein the training wheel is an omnidirectional wheel.

7. The training wheel assembly of claim 6, wherein the omnidirectional wheel comprises:
a plurality of rollers circumferentially disposed about an outer edge of the training wheel.

8. The training wheel assembly of claim 7, wherein the plurality of rollers are oriented for rotation orthogonal to a rotation axis of the training wheel.

9. The training wheel assembly of claim 1, wherein the distal end of the support arm is adjustably attached to the proximal end of the support arm.

10. A training wheel assembly for a bicycle, comprising:
a bracket having a base adapted for attachment to a frame of the bicycle;
a support arm pivotally coupled to the bracket a pivot pin extending through a proximal end of the support arm;
a distal end of the support arm adapted to rotationally carry a training wheel; and
an adjustment pin adjustably attached to the bracket, the adjustment pin limiting an upward movement of the support arm when an attached training wheel contacts a ground surface.
